(19) United States
(12) Patent Application Publication
(10) Pub. No.: US 2008/0258440 A1
(43) Pub. Date: Oct. 23, 2008

(54) Airbag system, vehicle seat comprising an airbag system and deployment method for an airbag system

(76) Inventor: Helmut MULLER, Russelsheim (DE)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/101,174

(22) Filed: Apr. 11, 2008

Related U.S. Application Data
(63) Continuation of application No. PCT/DE2006/001796, filed on Oct. 12, 2006.

(30) Foreign Application Priority Data
Oct. 12, 2005 (DE) 20 2005 016 006.7
Oct. 31, 2005 (DE) 20 2005 017 028.3
Mar. 16, 2006 (DE) 20 2006 004 222.9
Apr. 5, 2006 (DE) 20 2006 005 554.1

(51) Int. Cl. B60R 21/207

(52) U.S. Cl. 280/728.3

(57) ABSTRACT

The invention relates to an airbag system in which an integrated opening mechanism is automatically fastened at the same time as the airbag module, a vehicle seat comprising such an airbag system, and a method for deploying such an airbag system

### CROSS REFERENCE TO RELATED APPLICATION

This application is a continuation of International Application No. PCT/DE2006/001796, filed Oct. 12, 2006, which claimed priority to German Utility Model Application Nos. DE 20 2005 016 006.7 (filed Oct. 12, 2005); DE 20 2005 017 028.3 (filed Oct. 31, 2005); DE 20 2006 004 222.9 (filed Mar. 16, 2006); and DE 20 2006 005 554.1 (filed Apr. 5, 2006). The entire contents of this International Application and each of these German Utility Model Applications are incorporated herein by reference.

### FIELD OF THE INVENTION

The invention relates to an airbag system, a vehicle seat comprising an airbag system and a deployment method for an airbag system.

### BACKGROUND OF THE INVENTION

The application of the invention concerns all automobile vehicles, aircrafts and water crafts, even though the following description covers an automobile vehicle seat as an example. Mainly automobile vehicle seats, but also the above mentioned crafts in general, receive and include more and more safety features and—equipment. Especially the thorax airbags are integrated in such seats as an airbag device.

A further design of the technology according to patent application DE 198 60 840 A1 and the parallel U.S. Pat. No. 6,299,197 as well as the PCT-application PCT/DE 2005/000765 in each case coming from the same patent applicant concerning airbags covered by textiles or similar which are opened by the principle of a run, this invention deals with the mass production and a certified mounting and its impact to the entire system.

In summary these preceding applications show a ripping means as a ribbon, a thread or similar, sewn up with the passage seam for the airbag. Resulting from a specific guidance the ripping means/ribbon is mounted in a way that the airbag deployment applies such a force so that a run or a hole is cut by the ripping means into the passage seam. Afterwards the airbag is able to open up the passage seam easily. This system works better than all other systems and is independent from the kind of the seam as well as the quality of the textile.

According to the state of the art the problem of the difficulty to open the passage seam is solved differently: the seams are weakened and need a cuff that is additionally sewn up. Further it is necessary to apply textiles with little stretch only. These solutions are highly sensitive to manufacturing and material. Extensive quality assurance tests are necessary.

### SUMMARY OF THE INVENTION

The present invention concerns improvements of all previously listed techniques and construction samples referring to the patent application DE 198 60 840 A1 and the parallel U.S. Pat. No. 6,299,197 as well as the PCT-application PCT/DE 2005/000765, especially referring to the construction method of the airbag module and its assembly and function. In this respect the entire contents of previous applications especially regarding the layout of the airbag modules, its mounting and its function is included in the following by reference to avoid recurrences.

The present invention intends and achieves the goal to improve former known technologies.

The invention creates an airbag system with an airbag module whereat an integrated opening method is fixed at the same time as the airbag module.

In a beneficial manner the following invention solves the problem of automatic supervision at mounting the ribbon in mass production and therefore it influences the favored ribbon technique.

The further layout is designed separately or in any combination so that
the connection is a screw with a controlled torque,
the connection are rivets or similar controlled by electronic measures,
the bottom of an airbag module is fixed at the same time as the ripping means and this fixing is certified,
the airbag module has a lid, and this lid has got a passageway for the connection of the ripping means,
the airbag module has a lid, and this lid is reinforced at its front edge, whereat especially the reinforcement serves as a guide for the ripping means/ribbon when the airbag deploys, while the ripping means/ribbon is lifted up or turned so that it comes out of the airbag seam, and/or
ripping means are used in terms of a woven ribbon or especially a woven piece of textile serving as a ribbon, whereas it can be decided further
that the ripping means/ribbon is sewn in T-shape in order to rip a maximum sized hole
that the ripping means/ribbon is sewn in V-shape in order to achieve the highest possible peel-effect, and or
that the ripping means/ribbon is sewn in X-shape in order to obtain a large hole in the joining seam.
A further advantage is to sew the ribbon into the joining seam to achieve low ripping forces, and/or that at least a ribbon is sewn to the location where the airbag is scheduled to exit at first.

Further layouts are designed separately or in any combination so that
the ribbon system includes the turnaround guide and the screw readily fixed to the seat cover to obtain a certified screw on,
a “soft cover”-module is contained and its layout includes the ribbon opening mechanism as well,
where as a favor the lower half of the soft cover is laid out to protect the foam against particle flyers, and/or
the upper soft cover-half provides a hole for holding the mounting screw for the ribbon and the module, and/or
one soft cover-half is reinforced appropriately so that it carries the ribbon with it during opening simultaneously, and/or
the soft cover-module provides a skeleton of sheet metal moved through the base of the airbag, whereas the sheet metal skeleton is laid out with included hooks. These hooks are hooked into the seat rest structure. The sheet metal skeleton also provides a mounting hole to be used in combination with the ribbon to be mounted with one common screw.

This invention creates meanwhile also the appropriate vehicle seat with such an airbag system and a release system for such an airbag system. Further the invention creates a mounting system for such an airbag system.

Preferable and/or advantageous layouts of this invention result from the claims and their combinations and from the description of the embodiments in general.

### BRIEF DESCRIPTION OF THE DRAWINGS

The invention is explained in more detail by way of example with the aid of the following embodiments with reference to the drawings:

FIGS. 1 to 14 are exemplified embodiments of the invention.

FIG. 1 shows a section drawing of a seat back with an airbag module according to the present invention.

FIG. 2 shows important details with regard to the embodiment in accordance to FIG. 1

FIG. 3 shows the moment of deployment of an airbag according to the present invention.

FIG. 4 shows an airbag module from the top view where the ribbon is tilted to the left and to the right side.

FIG. 5 shows a section of the airbag module of the modified area.

FIG. 6 shows section “A” of FIG. 5.

FIG. 7 shows section “B” of FIG. 5.

FIG. 8 shows section “C” of FIG. 5.

FIG. 9 shows different varieties for layouts and designs of the ribbon.

FIG. 10 shows another alternative of the ribbon.

FIG. 11 shows an alternative solution for using the ribbon.

FIG. 12 shows another possible solution for the sewn ribbon.

FIGS. 13 and 14 show a module box enwrapped with the ribbon.

### DETAILED DESCRIPTION OF THE DRAWINGS

The invention does not only refer to the following explanations and examples, as these do only exemplify the invention, but comprises adequate designs which arise from different features and requirements.

The features explained in the following are not restricted to these examples and to the combination of given features, but can be combined with all other technical versions even though they might not be exemplified in the application.

Identical references within the drawings indicate identical or analog components. The drawings also show features not noted with references and not described within the text.

Further the text may contain features not shown in the drawings which are understandable and coherent for experts.

The list of references is an integral part of the explanation.

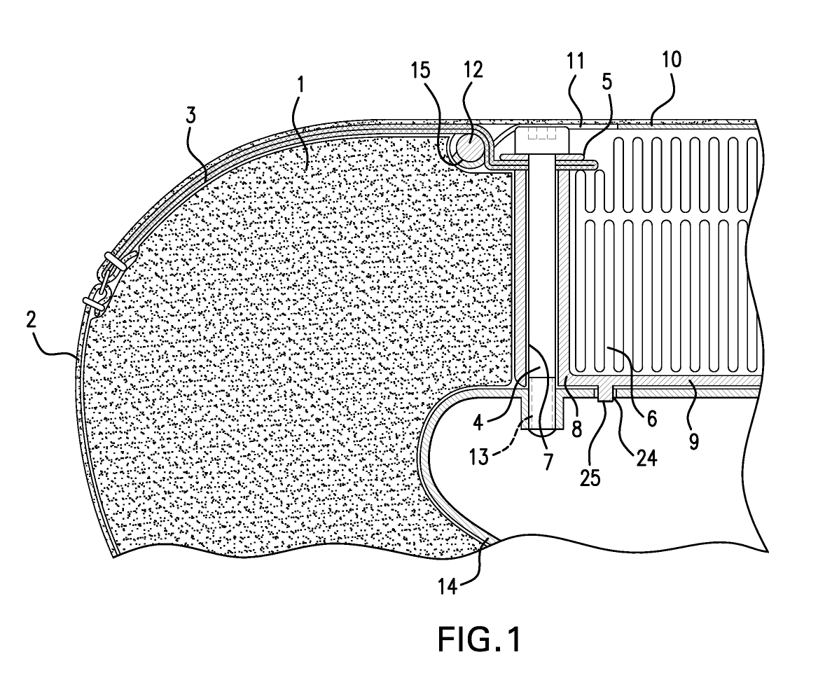

FIG. 1 shows the sectional drawing of the seat back 1 with a cover cloth 2, where a ribbon 3 is sewn in. The ribbon 3 is fixed with a screw 4 and a washer 5. An airbag module 6 is cast on the bottom 9 of the module together with a reinforcement 7 with a passageway 8. A lid 10 of the airbag module 6 provides a passageway 11 for mounting the ribbon 3 with the screw 4. A reinforcement 12 is cast at the front edge of the passageway 11. On assembly the assembled ribbon 3 with its screw 4 and its washer 5 are bolt together on the seat back frame 14. As the ribbon 3 is fixed at the cover cloth 2, the screw connection must be done when the cover cloth 2 mantles the seat back frame 14 half ways. In doing so the module bottom 9 is bolt over the reinforcement 7. As a result the ribbon 3 is positioned on an integrated guide 15 in the lid 10. Advantageous and therefore preferable is the fixing of the ribbon 3 and the airbag module 6 with help of an electronically supervised screwdriver (not shown). Resulting from this only seat backs 1 with correctly bolt airbag modules 6 and ribbons 3 leave the assembly line (not shown).

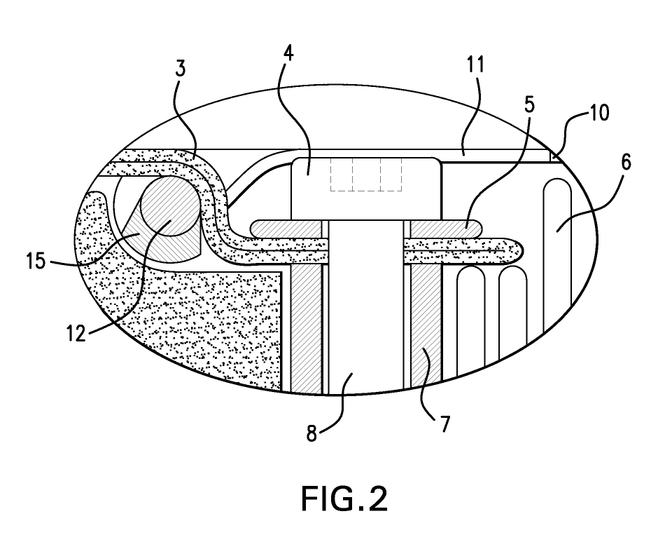

FIG. 2 shows important details with regard to the embodiment in accordance to FIG. 1.

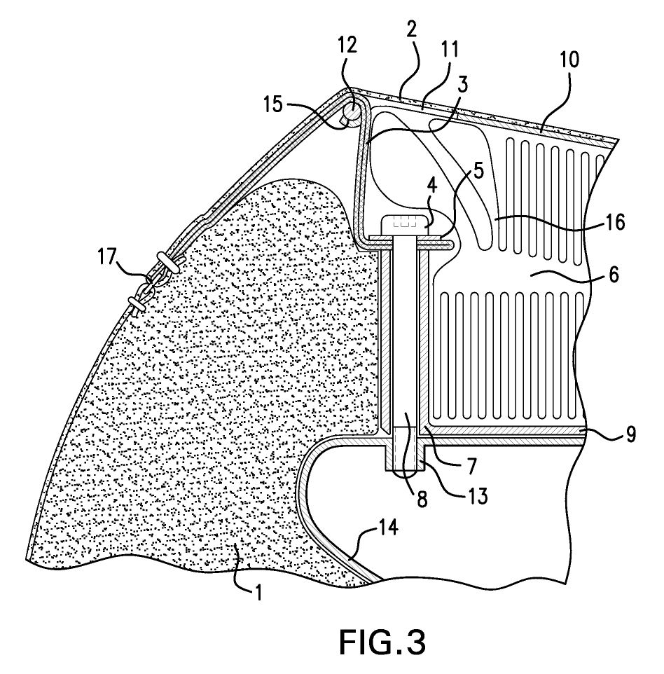

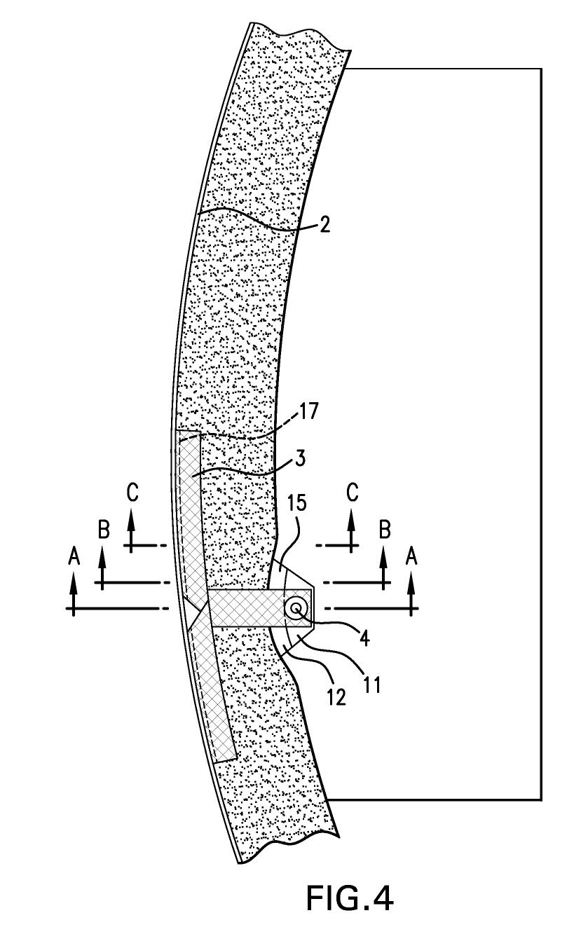

FIG. 3 shows the moment of deployment of the airbag 16. The airbag 16 lifts the lid 10 of the airbag module 6. This lifts up the guide 15 and therewith the ribbon 3 is shortened. Exiting the airbag 16 hits the ribbon 3 at both sides. FIG. 4 shows the airbag module 6 from the top view where the ribbon 3 is tilted to the left and to the right side. The airbag 16 pushes against the ribbon 3 till it is cut out of the seam 17. From the resulting hole (not shown) the airbag 16 opens the cover cloth 2 at the airbag opening seam 17 like a zipper. Therefore it is necessary, that the ribbon 3 is sewn to the seam 17 in the cover cloth 2 and moved through the hole 11 in the module 6 to be screwed on with the airbag module 6. Automatically the ribbon 3 will be located on top of the reinforcement 15 of the lid 10.

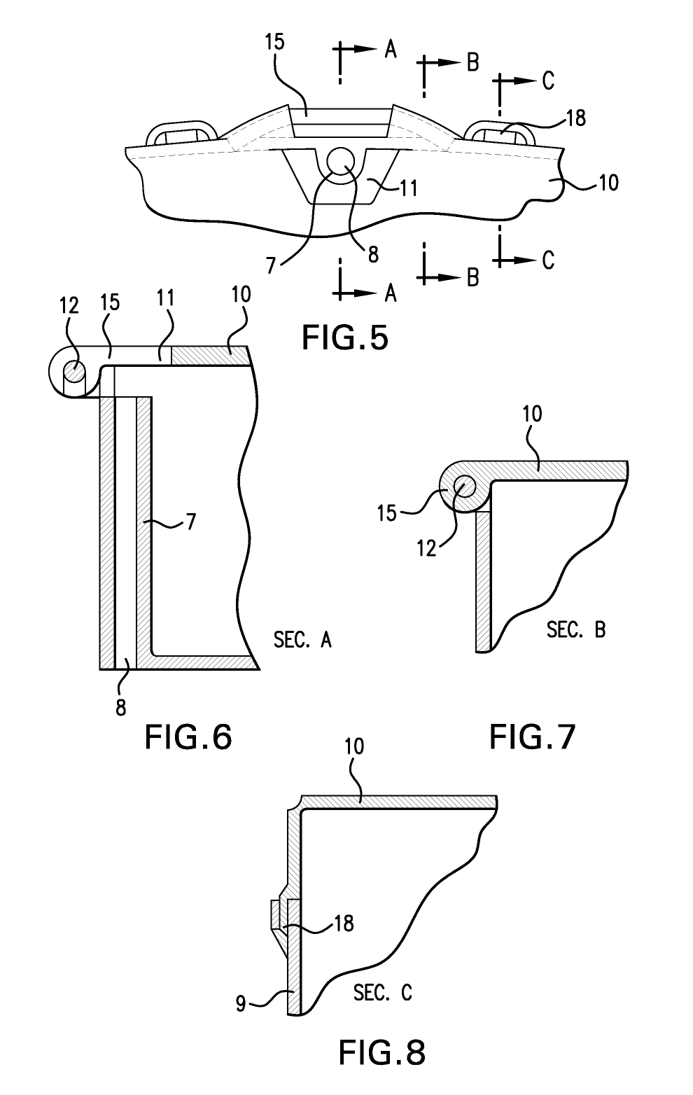

These 3 steps are to be found in FIGS. 5 to 8. FIG. 5 shows a section of the airbag module 6 of the modified area. Located in between the usual connection 18 between lid 10 and module base wall 9 there is a through passing hole 11 inside the lid 10 and the reinforcement 12. FIG. 6, section “A” shows the middle section of the tube shaped reinforcement 7 of the module base wall 9 and the lid 10 the through passing hole 11 for the ribbon 3 and its screw 4 and the reinforcement 12 and its turn around guide 15. Section “B” shows the reinforcement 10 inside the lid 10. Section “C” shows the usual and beneficial connection 18 between the module base wall 9 and the lid 10.

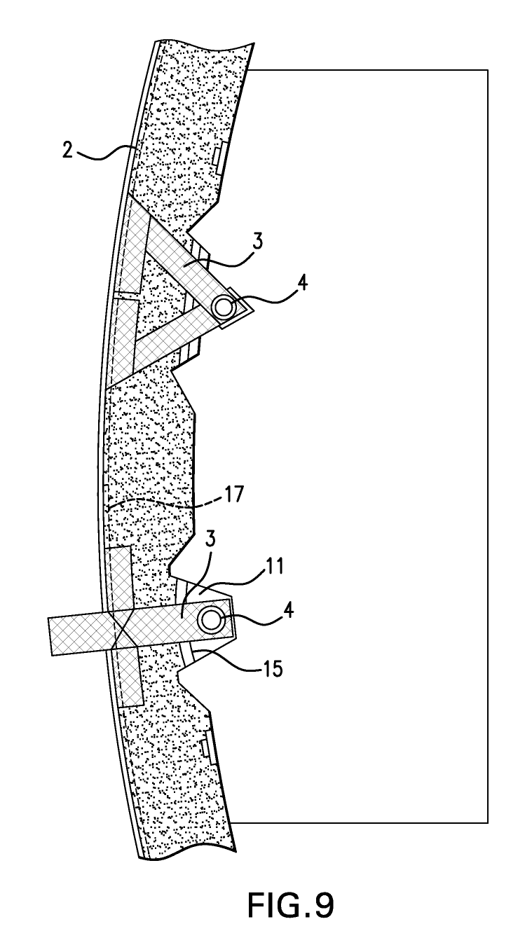

FIG. 9 shows different varieties for layouts and designs of the ribbon 3. The opening for the deployment of the bag is torn in an optimal diagonally inwards way by the upper ribbon 3, in this case used for a thorax bag. The lower ribbon 3 shows the possibility for the exit of a pelvis bag in this case. The ribbon 3 passes through the seam 17 to the visible outside. There the logo “airbag” or “SRS” can be written onto the surface of the ribbon 3.

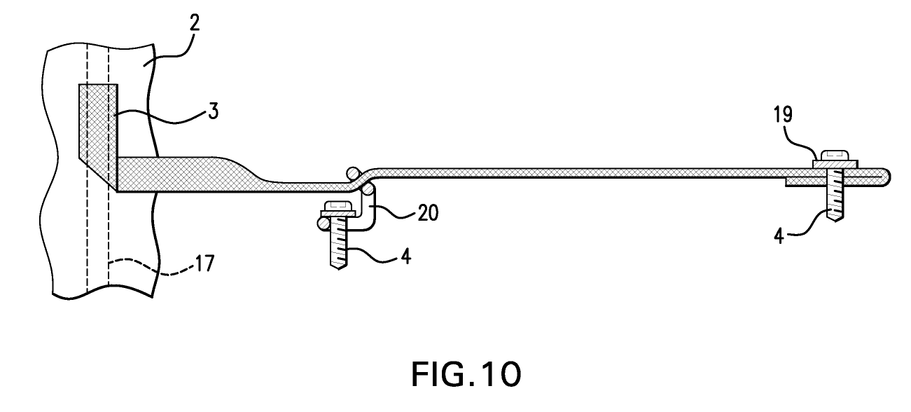

FIG. 10 shows another alternative: the ribbon 3 can be screwed to the backside of the airbag module 6 for example together with a generator (not shown). In this case the ribbon 3 provides a guide 20 next to the fixation 19, which can be screwed to the bottom of the module 9 or to the seat back frame 14. The ribbon runs right across the airbag module 6.

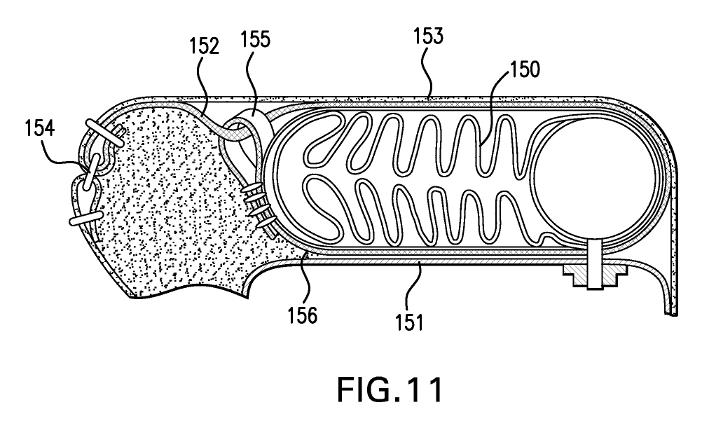

FIG. 11 shows an alternative solution for using the ribbon 152 in order to open smoothly the airbag opening seam. As before the ribbon 152 is sewn together with the airbag opening seam 154. But this solution provides a guiding loop 155 of a smooth material, e.g. a textile. Alternatively this guiding loop 155 can be a strip or a ribbon, as well one end of the ribbon 152. In this case the ribbon 152 is pushed through the guiding loop 155 so that a large loop 156 is created. During mounting the airbag module 150 can be inserted through this loop 156 and screwed to the ribbon 152.

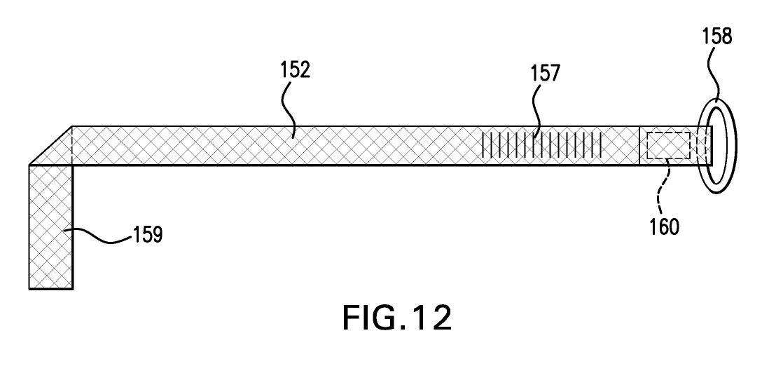

The example in FIG. 12 shows another possible solution for the sewn ribbon 159. Replacing the guiding loop 155, there is a chain link 158 sewn in so that the ribbon 152 can run with low friction. The imprinted barcode 157 serves as positioning help which will be explored in further examples.

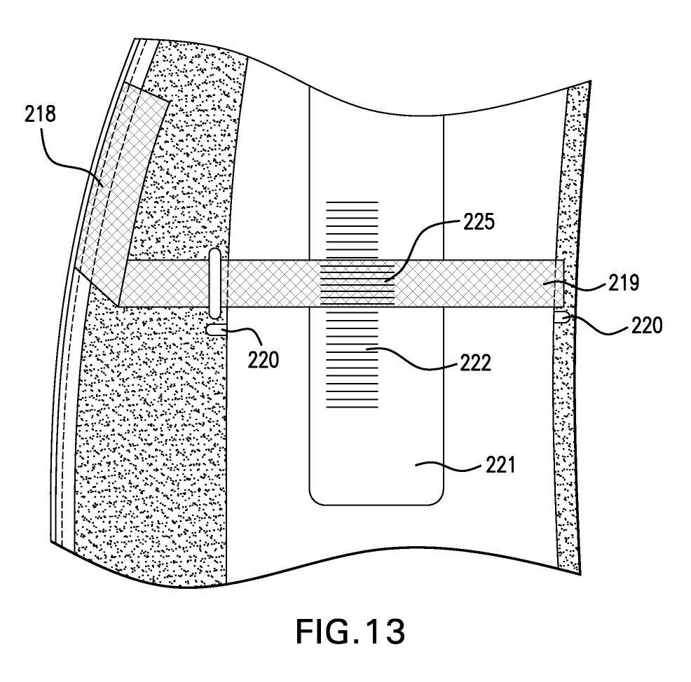

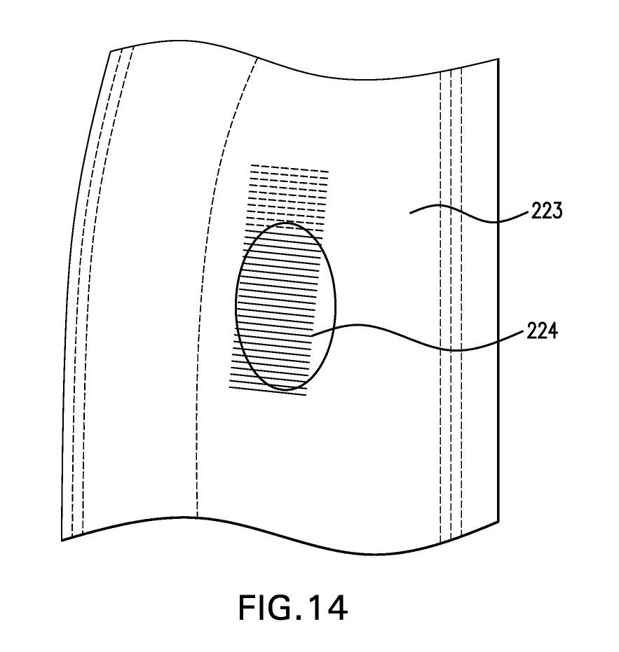

As shown in FIGS. 13 and 14, a module box 201 is enwrapped with the ribbon 218, so that the ribbon 218 creates a loop 219. This loop 219 is fixed on guiding notches 220. If desired or afforded that the laying of the loop is certified, this can be realized by an adhesive label 221 which is exactly positioned e.g. by a robot and is provided with a barcode 222. If in correct position, the loop 219 covers a particular area of the barcode 222. This can be checked by a bar-code stylus data recording system. All necessary data and the information about the correct location can be scanned simultaneously. The loop 219 has also got a barcode 222 being in line with the barcode 225 on the module, which guarantees that the loop 219 is mounted correctly in horizontal direction without twist. Further incorrect right-left reversed mounting is eliminated. FIG. 14 shows an alternative for this technique. Nowadays airbag modules for seats are often inserted into a cuff 223. A complex video supervision still results in faulty certification. As described before using the barcode-technique this problem is solved. A hole in the cuff 223 that is positioned at a predetermined place opens the view of the desired section of the barcode 224.

In the following some of the advantages of an airbag system according to the invention providing a ribbon system, a hard cover module and a ribbon loop are exemplified. Here the ribbon opens the none weakened seam with low force at a predetermined location. This has several advantages:
1. The seams do not have to be adjusted. Thread- and seam-strength with a tolerance of more than 100% have no influence. A double seam is not noticeable because its strength is far away from 1000 N. This is proven in test runs and can also be exemplified at the bench vise.
2. Stretching of seat cover textiles is irrelevant as well, because the ribbon always stretches far less. The more stretchable a seat cover textile is, the easier it is to upholster and the cheaper the textile is in common.
3. There are no flyers of foam particles because the front wall of the module protects the foam. This is proven in tests.
4. OOP—(Out-of-position-) behavior is advantageous: an airbag deploys much smoother from a 100 N to 200 N seam than one that needs to pass a 1000 N stiff seam. The opening location can be easily adjusted to OOP—this means that the opening location can be there where a lower risk of injury is.
5. Crash-behavior is much better because the side wall minimizes the opening area. Squeezing through a small gap with a seam of 1000 N strength is harder to open for the airbag than one with a 100-200 N strong seam. Further resulting from the “pulley-effect” the length of drawing-in of the ribbon is doubled, e.g. the opening seam is readily opened when the bag is just halfway opened in comparison to the cuff.
6. In case of product liability the USA assumes that the customer is offered the best possible product that is free from defects. The illustrated version can be proven to be the best. A faulty mounting is impossible (poke yoke), whereas the cuff version implicates more problems and risks.
7. Certification of correct mounting: in the ribbon system with loop the module is inserted through the ribbon loop and then the loop is fixed on guiding notches. The ribbon is then positioned on the barcode of the module. This barcode contains all data according to custom but also the information about the correct location of the ribbon The ribbon also provides a barcode being in line with the barcode of the module, which guarantees that the loop is mounted correctly in horizontal direction without twist. Further incorrect right-left reversed mounting is eliminated. Both barcodes lay cross-over within a certain tolerance and are checked simultaneously by a bar-code stylus data recording system.

Summarizing the above, the invention concerns an airbag system and especially a deployment method for airbags, which exits through a sewn cover. One advantage of this system is that both the module and the ribbon system can be fixed at once, so that it is guaranteed that the whole mounting can be certified. Further this system is cost-saving as the cuff—the usually sewn in reinforcing textile—and the weakening of the opening-seam are not necessary anymore. The combined fixing of the ribbon and the module offer another advantage because without additional effort all necessary data can be supervised electronically and are therewith certified. Further optimizing variants and other variants for thorax bags are exemplified focusing on safe certified mounting, better appearance, better function and lower costs.

The invention is described, merely by way of example, with the aid of embodiments in the description and in the drawings, and is not restricted to them but rather comprises all variations, modifications, substitutions, and combinations that the specialist can deduce from the documents under consideration, in particular, within the scope of the claims and the general representations in the introduction of this description and the description of the embodiments and their representations in the drawings and can combine with his expert knowledge and the state of the art, in particular including the complete disclosure contents of the older applications indicated at the beginning of this description. In particular, all individual features and configuration possibilities of the invention and their embodiments can be combined.

### REFERENCE NUMERALS

1 seat back
2 cover cloth
3 ribbon
4 screw washer
6 airbag module
7 reinforcement
8 passageway
9 bottom lid
11 passageway
12 reinforcement
14 seat back frame guide
16 airbag
17 seam
18 connection
19 fixation guide
152 ribbon
154 opening seam
155 guiding loop
156 large loop
157 barcode
158 chain link
159 sewn in ribbon
201 module box
218 ribbon
219 loop
220 guiding notches
221 adhesive label
222 barcode module
223 cuff
224 barcode section
225 barcode ribbon

1. Airbag system with an airbag module, wherein the airbag module and an integrated opening mechanism are fixed simultaneously.

2. Airbag system according to claim 1, wherein the connection is a screw with a controlled torque.

3. Airbag system according to claim 1, wherein the connection are rivets or similar controlled by electronic measures.

4. Airbag system according to claim 1, wherein the fixing of the bottom of an airbag module together with the ripping system is certified,

5. Airbag system according to claim 1, wherein an airbag module has got a lid, and the lid provides a passageway for connecting a ripping means.

6. Airbag system according to claim 1, wherein an airbag module that has got a lid, and the lid provides a reinforcement at its front edge.

7. Airbag system according to claim 1, wherein the reinforcement serves as a guide for the ripping means/ribbon at deployment while the ripping means/ribbon is lifted up and exits from the airbag opening seam.

8. Airbag system according to claim 1, wherein the provision of a ripping means that is made of a woven ribbon or any other woven shape in order to build a ribbon.

9. Airbag system according to claim 8, wherein the ribbon is sewn in T-shape in order to tear a maximum large hole.

10. Airbag system according to claim 8, wherein the ribbon is sewn in V-shape in order to achieve a larger peel-effect.

11. Airbag system according to claim 8, wherein the ribbon is sewn in X-shape in order to obtain a large hole in the joining seam.

12. Airbag system according to claim 11, wherein the ribbon is sewn with the joining seam in order to reach lower opening forces.

13. Airbag system according to claim 11, wherein at least one ribbon is sewn in at the location where the airbag is supposed to exit first.

14. Airbag system according to claim 11, wherein the ribbon system includes the turnaround guide and the screw readily fixed to the seat cover to obtain a certified screw on.

15. Airbag system according to claim 11, wherein a “soft-cover”-module is contained providing the ribbon system.

16. Airbag system according to claim 15, wherein the lower softcover-half covers the foam so that foam particle flyers is impossible.

17. Airbag system according to claim 16, wherein the upper and the lower half of the soft-cover provides a hole for holding the fixing screw for the ribbon and the module.

18. Airbag system according to claim 17, wherein the ribbon guide is included which is a flexible part of a loop.

19. Airbag system according to claim 18, wherein the ribbon guide is built in a way that the flexible part is a sewn in loop.

20. Airbag system according to claim 19, wherein the ribbon guide is built in a way that the guiding loop is one end of the ribbon.

21. Airbag system according to claim 20, wherein the ribbon and the loop are mounted in a way that the ribbon that is stuck through the loop builds another loop.

22. Airbag system according to claim 21, wherein the end of the ribbon loop is a chain link which guides the ribbon.

23. Airbag system according to claim 21, wherein mounting the ribbon system takes place by inserting the airbag module through the large loop and screwing in the module together with the ribbon.

24. Airbag system according to claim 23, wherein assembly parts and a barcode for supervision of correct assembly of the assembly parts are provided. These are laid out in a way that the readability depends on the correct placement of the assembly parts and/or the airbag module. The correct placement of the assembly parts and/or the airbag module is approved by a bar-code stylus data recording system.

25. Airbag system according to claim 22, wherein the barcode can check the ribbon-opening mechanism.

26. Airbag system according to claim 22, wherein the barcode can check the cuff-system.

27. Airbag system according to claim 26, wherein a barcode is included that provides data concerning the airbag system like date, type and/or charge and/or other information as well as the positioning information and that preferably all this data can be scanned simultaneously.

28. Vehicle seat, wherein an airbag system is contained according to claim 27.

29. Release system for an airbag system, wherein an airbag system is used and operated in keeping with its objectives and shape, in accordance with claim 28.
